(19) United States
(12) Patent Application Publication
(10) Pub. No.: US 2007/0294127 A1
(43) Pub. Date: Dec. 20, 2007

(54) System and method for ranking and recommending products or services by parsing natural-language text and converting it into numerical scores

(75) Inventor: Ami Zivov, (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Viewscore Ltd, Tel Aviv (IL)

(21) Appl. No.: 11/659,643

(22) PCT Filed: Aug. 4, 2005
(86) PCT No.: PCT/IL05/00839

§ 371 Date: Feb. 2, 2007

Related U.S. Application Data
(60) Provisional application No. 60/598,915, filed on Aug. 5, 2004.

(51) Int. Cl. G06F 17/30

(52) U.S. Cl. 705/10

(57) ABSTRACT

A system and method for ranking consumer products and services is disclosed. The system includes automated ranking module that calculates scores for each applicable product according to review information crawled from the Internet or any digital or published media.

### FIELD OF THE INVENTION

One or more embodiments of the invention have the applicability in the field of computer software. More particularly the invention is directed to a method and apparatus for calculating the score and the ranking of a given product or service in a given category.

Data in a “natural-language” format is harvested from the Internet and from local database then parsed and processed mathematically to a score that is later translated to a ranking.

### BACKGROUND OF THE INVENTION AND RELATED ART

In the eCommerce market in general and more specific in the comparison shopping field, users face Two questions, the first one is “what to by?” and the second one is “where to buy?”

In general, comparison shopping portals that does price aggregation, focus on a price scan, trying to answer the “where to buy?” question but neglect the “what to buy?” question by providing a few users reviews without any real mathematical or statistical ranking of these reviews.

When an on line user today focuses on the “what to buy?” dilemma he is using several tools for making that decision, tools that are highly time consuming and require some technical knowledge and ability to search the internet for relevant and helpful information

One part of the Internet is the World Wide Web (WWW). The WWW is generally used to refer to both (a) a distributed collection of interlinked, user-viewable hypertext documents (commonly referred to as a “web documents” or an “electronic pages” or as “home pages”) that are accessible via the Internet, and (b) the client and server software components which provide user access to such documents using standard Internet protocols. The web documents are encoded using Hypertext Markup Language (HTML) and the primary standard protocol for allowing applications to locate and acquire web documents is the Hypertext Transfer Protocol (HTTP). However, the term WWW is intended to encompass future markup languages and transport protocols which may be used in place of, or in addition to, HTML and HTTP.

The WWW contains different computers which store electronic pages, such as HTML documents, capable of displaying graphical and textual information. The computers that provide content on the WWW are generally referred to as “websites.” A website is defined by an Internet address, or Universal Resource Locator (URL), and the URL has an associated electronic page. Generally, an electronic page may advantageously be a document that organizes the presentation of text, graphical images, audio, and video.

Two of the most important tools that are being used by users are editorial reviews and benchmark information. This information is widely spread throughout the Internet and in the published media, and it is written in a natural language.

Another source of information is in the Format of consumer review information (user review). This type of information is very popular in the comparison-shopping portals and price aggregations services. This user review information is not analyzed and the buying users have to answer the “What to buy” question without any ranking system.

It would thus be desirable to provide an automated ranking service for products and consumer services by taking into account the natural language information gathered from editorial reviews, benchmarks, and user reviews. Indexing this information in a search engine database we can provide aggregation services for dedicated comparison shopping portals, thus help the users in making intelligent shopping decisions.

These users will be able to use this aggregated comparison service by allowing them to select a category of products and to use attributes filtering in order to receive only the relevant products from the ranking engine. The ranking engine will provide a list of products, in a descending order, according to the reviews information harvested from the Internet; each product will have a score and a category ranking.

The process of ranking products by editorial reviews and benchmarks results is very professional and provides a highly relevant ranking data. Combining this information with regular user's reviews in a weighted statistic search ranking engines can produce a very accurate data regarding the ranking and the score of each item that is being tracked in the ranking search engine.

### SUMMARY OF THE INVENTION

This patent application is for a system and method for:
1. Scoring of products in a normalized and systematic manner, based on editorial review texts, user reviews texts and other applicable texts.
2. Ranking of products according to their scores
3. Displaying the results on a web page (or any other applicable media) in an orderly fashion (for example: show first the products with the highest scores), taking into account also the end user preferences (for example: Display only products below a certain price limit)

The purpose of this system and method is to allow consumers who are facing a large selection of products (for example: Digital Cameras) to make an informed decision about which product will be the best choice for their money.

In one embodiment, the system returns the search results ranked, based on human editorial reviews combined with user experience\reviews information. This ranking is determined by an automated ranking process that takes into account the natural language information gathered from these reviews, along with a weighting algorithm that is controlled by a user interface.

The output of this process is a list of products beginning with the best/highest score product and ending with the products that has the lowest ranking/score.

In another embodiment a user can leverage the ranking engine to rank products that are filtered by the user with an “attribute search engine”, giving the user a better control over the ranking mechanism, and customizing the search attributes to fit the user needs and budget.

### BRIEF DESCRIPTION OF THE DRAWINGS

The present invention will become fully understood from the detailed description given herein below and the accompanying drawings, which are given by way of illustration only and thus not limitative of the present invention, and wherein:

FIG. 1 is a block diagram of the user interface traffic flow, describing the navigation and the options the users have;

FIG. 2 is a block diagram that illustrates the various scoring/ranking Calculator elements;

FIG. 3 is a block diagram that shows the interactions between the different elements of the voting system in the score calculator;

FIG. 4 is a block diagram that shows the interactions between the different elements of the editorial review “natural language” data in the score calculator;

FIG. 5 is a block diagram that shows the interactions between the different elements of the user review data in the score calculator;

FIG. 6 is a block diagram that shows the interactions between the different elements of the power user review data in the score calculator;

FIG. 7 is a block diagram that shows the interactions between manufacturer average score data stored in a database and the score calculator; and

FIG. 8 is a block diagram that shows the interactions with the aging algorithm calculator.

### DETAILED DESCRIPTION OF PREFERRED EMBODIMENTS

Embodiments of the invention will now be described, by way of example, not limitation. It is to be understood that the invention is of broad utility and may be used in many different contexts.

Several modules will be described hereafter. The modules may advantageously be configured to reside on an addressable storage medium and configured to execute on one or more processors. The modules may include, but are not limited to, software or hardware components that perform certain tasks. Thus, a module may include, for example, object-oriented software components, class components, processes methods, functions, attributes, procedures, subroutines, segments of program code, drivers, firmware, microcode, circuitry, data, databases, data structures, tables, arrays, and variables.

A product is an e.g., “digital camera” a product can come in a format of a service, for example “ISP internet service”. Thus we are referring to a “product” as any item or service that can be evaluated and review by a users or professional review service.

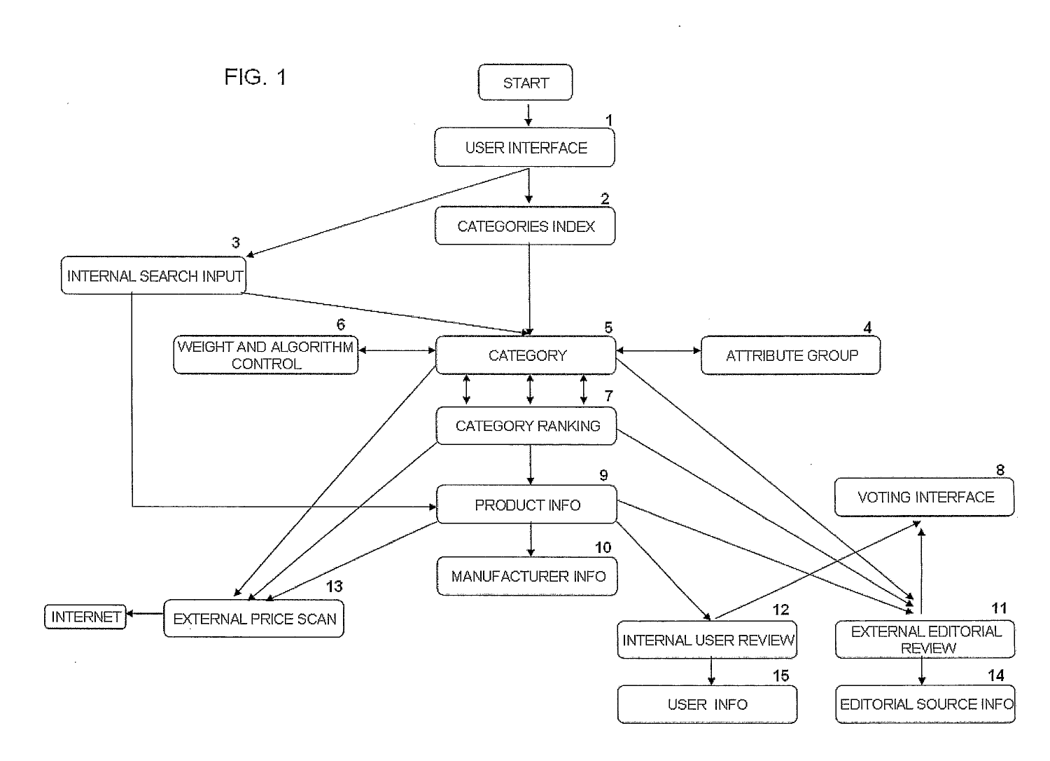

A Category is a category of products, e.g., “cars” or “electronics.” An Attribute Group (FIG. 1 object 4) is a group of attributes that apply to a particular category of products and whose controls are displayed together to the user. For example, the category “televisions” might have the attributes “27 inches” and “20 inches” belonging to the same attribute group “diagonal size.” Thus, if a user desires to search for televisions having either of these attributes, the search results could be shown together, because they are different values of the same measurement or in general are otherwise conceptually related.

Deep links are WWW links from one website SITE A to an internal page on different website SITE B. We are aggregating deep links relevant to our ranking data in a format of HTML links so the system can forward the users directly to relevant ranking information after they examine the system ranking data.

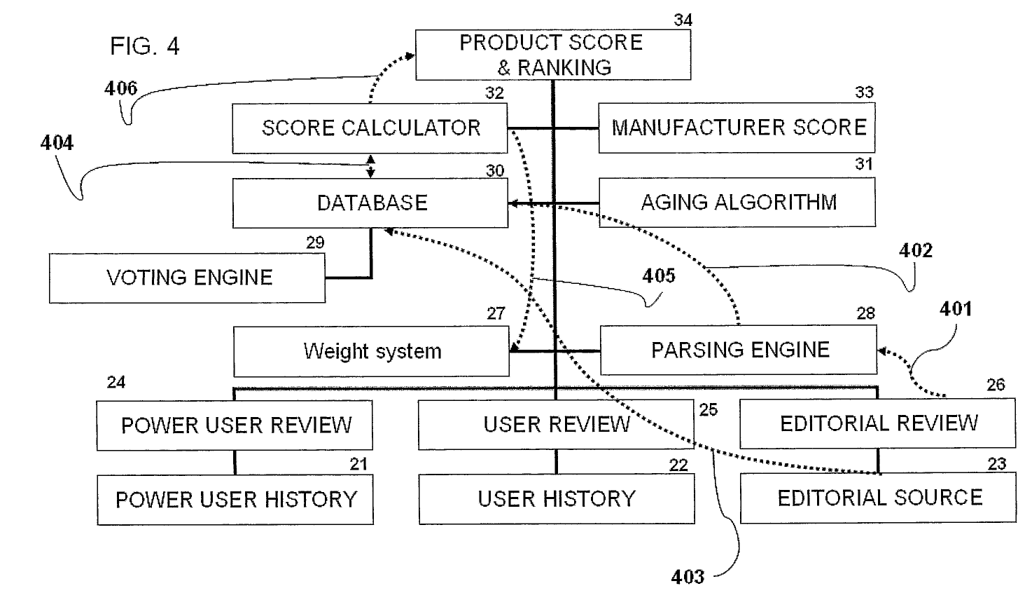

The present invention provides a method and apparatus for facilitating ranking between products and services. ECommerce buyers on the Internet WWW (World wide web) conduct a market research in order to decide what product will give them the highest value for the money they plan to spend. ECommerce buyers read professional reviews (FIG. 1 object 11) (editorial reviews) and also give some weight to consumer reviews (user reviews) (FIG. 1 object 12) and by reading this information they try to make a buying decision. All the reviews (editorial and user) are widely spread over the Internet but they are in a “natural language” format. In one embodiment, the ranking search engine will parse (FIG. 4 object 402) the “natural language” reviews to a mathematical value (0-100) and rank the items according to user configured weight system and statistics information (FIG. 1 object 6), the output of this process is a score and a ranking of each product or service.

FIG. 1 is a flow diagram providing an example of user interface in accordance with the present invention in which the ranking of the product is determined. By a way of example the invention will be discussed below in the context of a buyer conducting a market research for a “digital camera” for personal use an “Attribute Group” of at least 5 mega pixels, and with a budget of $500 US.

First, the buyer identifies his relevant category (FIG. 1 object 2) in order to focus the ranking engine to the relevant category; buyer can use the internal search engine (FIG. 1 object 3) to find the relevant category quickly and efficiently.

The buyer can use the internal search engine (FIG. 1 object 3) to go directly to the product's page (FIG. 1 object 9) in order to see the ranking and the score of that product. In addition the buyer can use the “deep links database” that is provided to read the external editorial reviews (FIG. 1 object 11) and internal User reviews (FIG. 1 object 12) of this product.

In this example the buyer has chosen the “digital camera” category (FIG. 1 object 5) and he is getting as an output the best products of this category as ranked by the ranking engine (FIG. 1 object 7).

In this example the user is filtering the results of the ranking engine to a price of no more than $500 US, and for personal use with the “attribute group” (FIG. 1 object 4) eliminating from the ranking engine all the “digital cameras” that are not under the category of personal use with a minimum of 5 mega pixels and the price limit of $500 US.

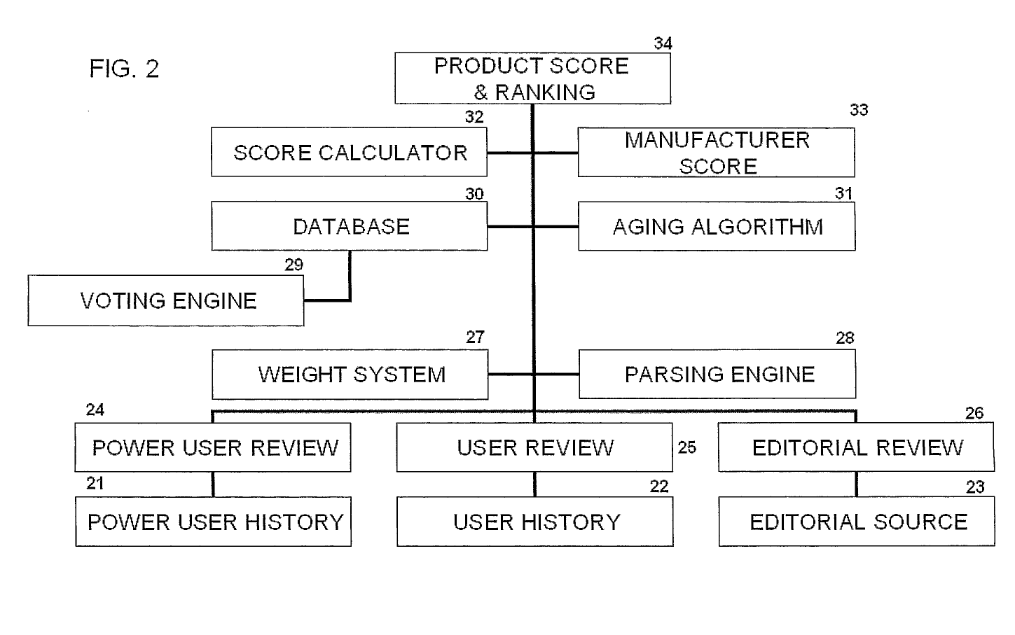

Ranking engine weight-and-algorithm control—(FIG. 1 object 6) users can control the way the ranking engine works by distributing the weights of the ranking engine algorithms (FIG. 2 object 27) between “user reviews” and “editorial reviews” as well as manipulating the algorithms by disabling or enabling the effect of the aging algorithms. (FIG. 2 object 31)

External price scan—(FIG. 1 object 11) the system diverts price scan requests to price scan aggregator's websites, by giving the users HTML links that contain the product's information at the header of the redirection. This process is being opened in a different window and is not monitored or controlled by our service.

Product-page—(FIG. 1 object 9) after the user has chosen a product from the list of results that were returned by the ranking engine he is redirected to the product's page (FIG. 1 object 9) which contains all the relevant information (including the user reviews and the external editorial reviews themselves, for this product) that the ranking engine has used in the ranking calculation process.

The product-page contains several elements, including the specification of the product, its ranking and its score information, deep links to all the editorial reviews related to this product and all the internal user reviews data.

In addition the buyer can find a few buying tools like an external price scan for the chosen product (FIG. 1 object 13).

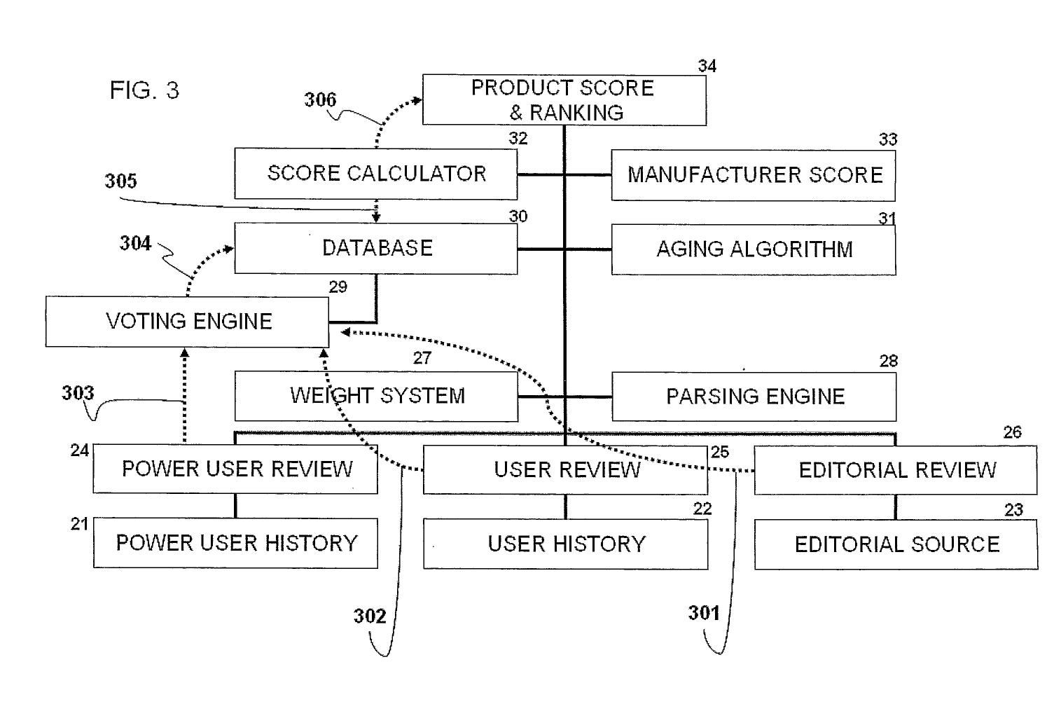

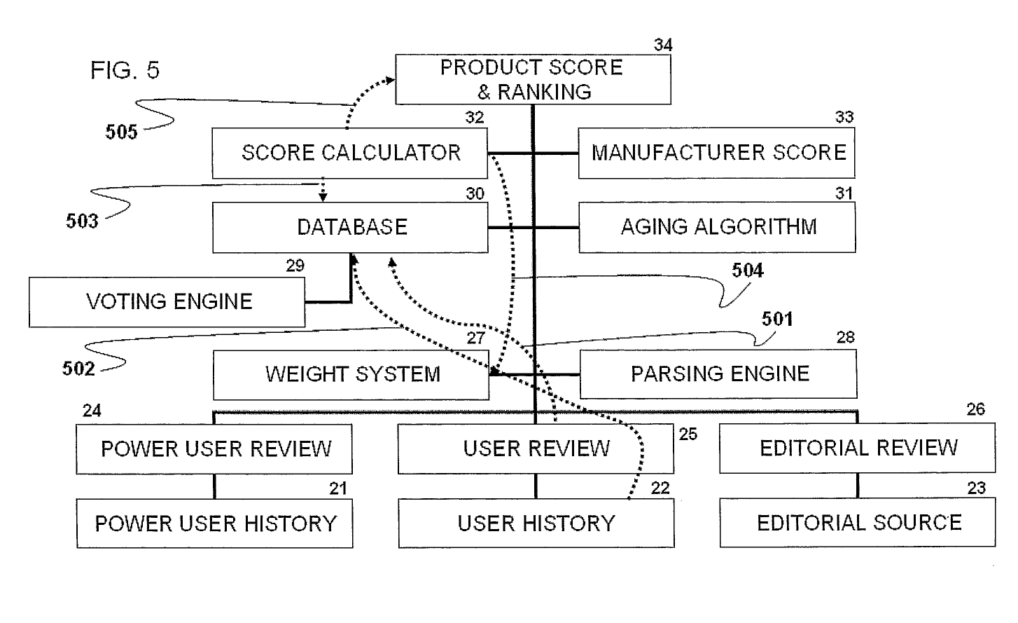

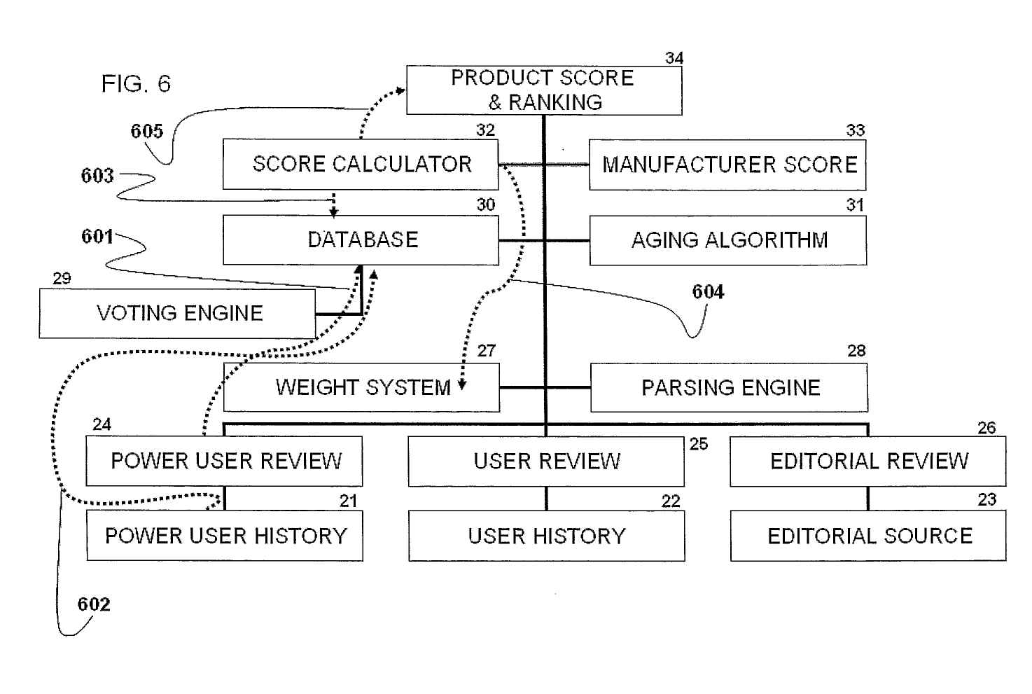

Voting interface (FIG. 1 object 8)—users are being asked to vote for the helpfulness of each review (user reviews—FIG. 3 object 302), power-user reviews (FIG. 3 object 303) and editorial reviews (FIG. 3 object 301)) in order to “teach” the system how to distribute the ranking weights automatically between the reviews sources according to the users experience and knowledge. The helpfulness votes are being recalculated (FIG. 4 object 401) (FIG. 5 object 502) (FIG. 6 object 602) in each stage of the ranking process, and they are monitored for frauds with an anomaly detection system, so no one can make multiple submissions of votes and “fake” the real helpfulness score of each review in the database.

Parsing engine-translates (FIG. 4 object 401) the “natural language” text to reflect a mathematical score. This can be done automatically or with the help of a category manager that has a deep knowledge regarding the relevant category the system will use an artificial intelligence technology in order to “teach” the system how to parse this information with minimal standard deviation, a statistical measurement is being used to mark the accidental error or mistake in the results of a parsing attempt.

Voting interface (FIG. 1 object 8) for the reflection of the scores of the Editorial's and user reviews the reviews are written in a “natural language” oriented and the “parsing engine” (FIG. 4 object 401) translating them to a mathematical score, users are given the option to vote for these mathematical scores, by doing so they decide whether the score should be higher or lower and thus, help our system adjust the score of this review to better reflect it's actual score.

In addition each vote improves the “parsing engine” and the AI technology in order to be more accurate and mimic human results for the execution of the “parsing engine”.

Mathematical normalization, by using the voting interface and by enabling users to interact with the system and influence every decision-making process, the system can use all the available information from the WWW and trust the normalization effect to give the users an accurate information without using dedicated professional human resources to filter the content and to make the ranking decisions.

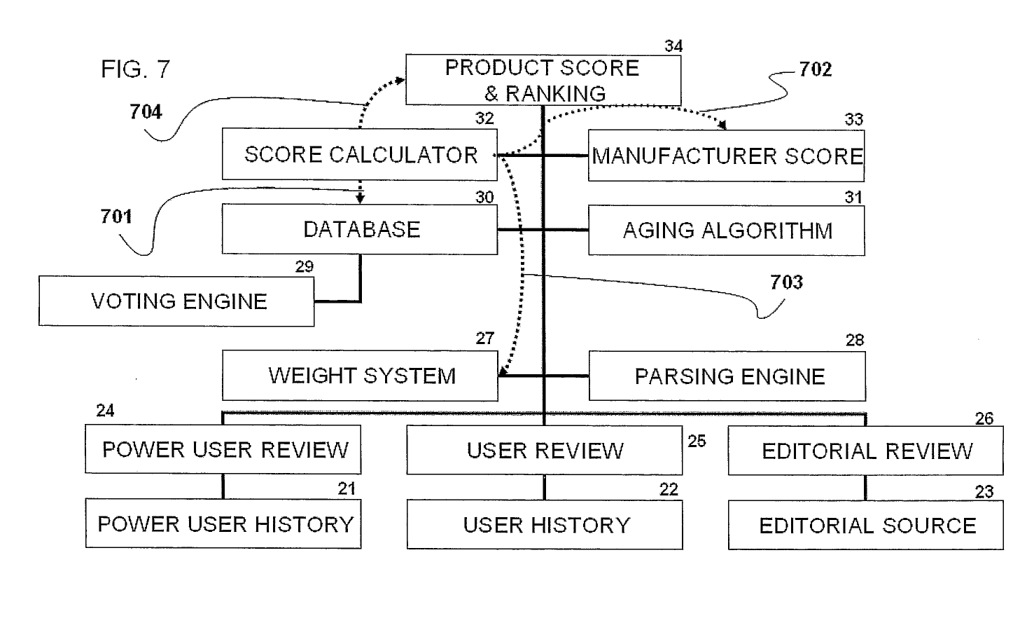

Manufacture info (FIG. 1 step 10)—because the system ranks products from different manufacturers and gives each of them a mathematical score (FIG. 7 object 701), taking into account the sum of scores of each manufacturer and its products average score, we can rank each manufacturer.

The ranking of a manufacturer is being analyzed by the score calculator (FIG. 7 object 704) diagram (FIG. 7) describes the process of calculating the manufacturers score (MS) the process takes into account not only the average score (FIG. 7 object 702) of the manufacturer's products but some performance parameters per given time as well.

The system can than make a statistics calculation (FIG. 7 object 704) that shows the ranking of each manufacturer globally and per category.
N=Number of products the number of products this manufacturer has in the database.
PpT=Products per X Time the number of products this manufacturer has manufactured during a Given time.
PSi=the Score of Product i
MS=Manufacture Score
W=a dynamic Weight for each argument (FIG. 7 object 703)

$${( \frac{{\sum }_{i} {PS}_{i}}{N} )}^{W 1} ⨯ {( N )}^{W 2} ⨯ {( PpT )}^{W 3} = MS$$

(Manufacturer Score Calculating algorithm)

Editorial source info—(FIG. 1 object 14) editorial source is a publication that is publishing editorial reviews to the media (ex. PC magazine).

The system indexes all the reviews and information from each publication so the users can browse and follow deep links to the editorial material and are able to vote (FIG. 1 object 8) for the helpfulness of each review.

Combining this information in the ranking algorithm (FIG. 4 object 403) allows the system to rank each editorial source (FIG. 4 object 406).
H=Helpful votes—the number of users that have found the source's reviews helpful.
NH=Non Helpful votes—the number of users that have found the source's reviews unhelpful.
RpT=Reviews per Time—the number of reviews this source has published during a given time.
N=Number of reviews of editorial source—the total number of reviews published by this source.
ESS=Editorial Source Score—the calculated editorial source score.
W=a dynamic Weight for each argument (FIG. 4 object 405)

$${( \frac{H}{H + NH} )}^{W 1} ⨯ {( N )}^{W 2} ⨯ {( RpT )}^{W 3} = ESS$$

(Editorial Source Score Calculating Algorithm)

User Info—(FIG. 1 object 15) the users of our service will post their user experience and conclusion regarding products and services in a user-review format. The system will index all the reviews and users relevant information so the users can browse this information freely.

Because the system allows the users to vote for the helpfulness of each user review it can establish a ranking and a scoring system for the users of our community (FIG. 5 object 501) (FIG. 6 object 601). The system will add to the score of each user community-transactions-static points in order to encourage the community usage.
H=Helpful votes—the number of users that have found the user's reviews helpful.
NH=unhelpful votes—the number of users that have found the user's reviews unhelpful.
RpT=Reviews per Time—the number of reviews this user has written during a given time.
N=Number of reviews of a specific user.—The total number of reviews published by this user.
US=User Score—the calculated user score.
W=A dynamic Weight for each argument
SP=Static community Points—points given by various actions in the system, like voting for others Reviews.

$${( \frac{H}{H + NH} )}^{W 1} ⨯ {( N )}^{W 2} ⨯ {( RpT )}^{W 3} + {SP}^{w 4} = US$$

(User Score Calculating Algorithm)

Users of the system are being ranked with a reflecting score “US” (FIG. 5 object 502) (FIG. 6 object 602) The system divides these users into several groups (FIG. 2 object 24,25), mainly for giving a higher weight for “Power users” over “Regular users” in the product ranking score calculator. (FIG. 5-6)

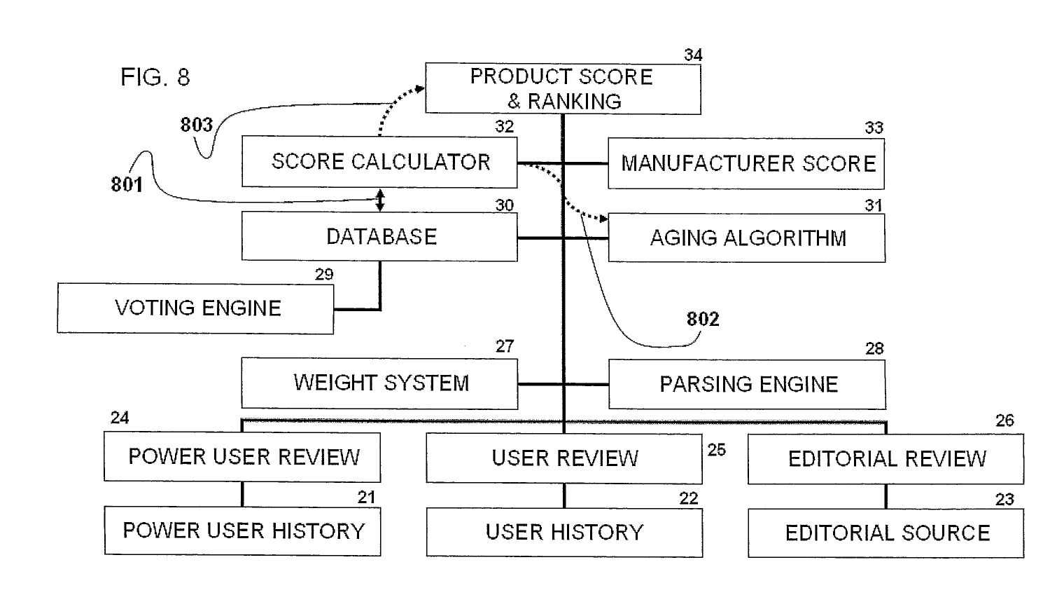

Aging algorithm—the system has to take the time parameters (FIG. 8 object 802) into consideration because a high ranked item that is X years old has the drawback of old technology. In order to fix this anomaly the system reduces the score of an item as time goes by.

This algorithm (FIG. 8) is adjustable in each category because each category has a different product life time.
AF=Aging Factor Based on the nature of the category, the number of months typically it takes a Product to Lose 10% of its score.
AR=Aging Rate How many points of score each product loses every day.

$$AR = \frac{0.1}{365.24 ⨯ ( \frac{AF}{12} )}$$
DOi=Days Old How many days ago was the i'th review written.
RSi=editorial Review Score The i'th review's score, before the aging.
RASi=Review Aged Score The aged score of review i. (can not exceed 100 or 0)
RASi=RSi[1−(AR×DOi)]

FIG. 4—Editorial review score calculator (FIG. 4 object 406). When editorial reviews are being added to the system the parsing engine will parse (FIG. 4 object 401) the natural language text to a reflecting score (1-100). This score ERISi (Editorial Review Score) is being generated in the parsing engine and stored in the database (FIG. 4 object 402) for a later use (FIG. 4 object 404). The ERISi can be changed over time by the voting system described on (FIG. 3 object 301). These changes are preformed dynamically as the system normalizes the results to better reflect the users experience and knowledge.

In addition the normalization process is improving the parsing engine.
MF=Maximum Influence The maximum influence the higher/lower votes may have on each review
VE=Vote Effect The influence each higher/lower vote has on the subject review.
HVi=Higher Vote the number of votes for higher score the i'th review received.
LVi=Lower Vote the number of votes for lower score the i'th review received.
HLEi=Higher/Lower Effect the effect the higher/lower votes has on product i.
HLEᵢ=(HVᵢ−LVᵢ)×VE
If (HLEi>MF) than HLEi=MF
If (HLEi<−MF) than HLEi=−MF
ERISi=Editorial Review Initial Score The initial score of review i.
RSi=editorial Review heighten Score The i'th review's score with the higher/lower votes effect, (can not exceed 100 or 0)
RSᵢ=ERISᵢ+HLEᵢ
RASi=Review Aged Score The aged score of review i, calculated using the aging algorithm on RSi
ERWi=Editorial Review Weight The calculated weight of the i'th review.
Hi=Helpful votes The number of users that have found the i'th review helpful.
NHi=Non helpful votes The number of users that have found the i'th review unhelpful.
ESSi=editorial source score The score of the source of the i'th editorial review.
PES=Product's Editorial Score The final aged editorials score of the product.

$$( \frac{{ESS}_{i}}{{\sum }_{i} {ESS}_{i}} + ( \frac{{H}_{i}}{{H}_{i} + {NH}_{i}} ) ) = {ERW}_{i}$$

$$\frac{\sum ( {RAS}_{i} ⨯ {ERW}_{i} )}{{\sum }_{i} {ERW}_{i}} = PES$$

(Editorial Review Score Calculating Algorithm)

FIG. 5-6—User reviews score calculator, when user reviews are being added to the system (FIG. 5 object 501), each user inputs a reflecting score. This score, USi, is being stored in the database for a later use (FIG. 5 object 503)

Each user review is being monitored by the users and helpfulness votes can be given to each user review (FIG. 3 object 302), thus giving the system the ability to rank the users reviews and the users themselves (FIG. 5 object 505).
URISi=User Review Initial Score The initial score of review i.
RASi=Review Aged Score The aged score of review i, calculated used the aging algorithm on URISi
URWi=User Review Weight The calculated weight of the i'th review.
Hi=Helpful votes The number of users that have found the i'th review helpful. (FIG. 5 object 502)
NHi=Non Helpful votes The number of users that have found the i'th review Unhelpful. (FIG. 5 object 502)
USi=User Score The score of the writer of the i'th review.
PUS—Product's User Score The final aged user score of the product.

$$( \frac{{US}_{i}}{{\sum }_{i} {US}_{i}} + ( \frac{{H}_{i}}{{H}_{i} + {NH}_{i}} ) ) = {URW}_{i}$$

$$\frac{{\sum }_{i} ( {RAS}_{i} ⨯ {URW}_{i} )}{{\sum }_{i} {URW}_{i}} = PUS$$

(User Review Score Calculating Algorithm)

Users can control the weight that is being given to the PUS (final aged user review) and PES (final aged editorial review) when scoring and ranking the products. (FIG. 4 object 405) (FIG. 5 object 504) (FIG. 6 object 604) (FIG. 7 object 703)

For example the user can adjust the ranking system to give 70% of the ranking weight to the editorials reviews (FIG. 4 object 405), 20% of the ranking weight to the power users reviews (FIG. 6 object 604) and 10% of the ranking weight for the regular users reviews (FIG. 5 object 504). More control can be given to the users by letting them disable the effect of the aging algorithms on the scores of the products (FIG. 8 object 803).

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention.

1. A system for allocating a numerical score (for example: 1-100) for a product, where this score is allocated based on a text article written by an expert (For example: An Editorial Review or an User Review). There are typically more articles written about any product, so there may be many scores allocated for each product.

2. A system for aggregating the many scores per product into a single score (the Product Score). The aggregation is being done using a weighted average mechanism. End users may use a voting scheme in order to influence the weights given to each score.

3. A system for taking into account the effect of new text articles that are added from time to time per product.

4. A system for taking into account the fact that as products are aging, and new products with better functionality and lower prices are introduced to the market, the Product Score should be adjusted accordingly.

5. A system for taking into account the views of users about the value and accuracy of the various sources, so that a source that many users indicate is of low value will receive a lower weight when calculating the Product Score.

6. The systems of claim 1, where the list of products (each product with the associated Product Score) is displayed on a web page.

7. The system of claim 6, where the display of the list of products can be filtered by selectable user criteria (for example, display only products that are below a certain price limit).

8. The system of claim 7, where the display of the list of products can further be filtered by selectable product attributes (for example; for Digital Cameras, show only those with at least 3× optical zoom and 5 Mega Pixel picture resolution).

9. The system of claim 1, where for each product there is an associated Product Page which is a web page that display information specific to each product. Such information will include as a minimum the Product Score and links to the sources (For example: Editorial Reviews, User Reviews) that were the basis for the calculation of the Product Score.

10. The system of claim 1, where for each product there is a link to another web site (or links to many web sites) where the consumer may actually buy the product.

11. The method of claim 1 wherein the search results are output in a product page format.

12. The method of claim 2 wherein the product page comprises deep links to editorial review content.

13. The method of claim 2 wherein The product page comprises user reviews data in text format.

14. The method of claim 1 wherein the product page comprises a technical specification that is relevant for the chosen product.

15. The method of claim 1 wherein the product page comprises mathematical ranking information and a reflecting mathematic score.

16. The method of claim 1 wherein the product page comprises an online buying tool in an external dynamic price scan format.

17. The method of claim 1 wherein the search result are output in a format of a category index containing a list of the best products in the category.

18. The method of claim 17 wherein the user can filter the results by entering target price for filtering out over-budget items item.

19. The method of claim 17 wherein the user can use the attribute group for filtering items that don't include the attribute characteristics.

20. The method of claim 17 wherein the user can control the weights used in the score calculation and distribute them freely between user reviews and editorial reviews.

21. The method of claim 17 wherein the user can arrange the results by indexing the search output by a descending or an ascending order of any given parameter.

22. The method of claim 17 wherein the user can enable or disable the aging algorithm.

23. The method of claim 17 wherein the user can focus the search on one or more manufacturer.

24. A computer-implemented method for facilitating a voting platform using a voting web interface comprises a normalization affect and weighting information.

25. The method of claim 5 wherein the voting platform is enabled for internal user reviews and external editorial reviews.

26. The method of claim 5 wherein the user can vote on the helpfulness of each review.

27. The method of claim 5 wherein the users can vote for the mathematic score of each review at any given moment comprises lower or higher voting option.

28. The method of claim 5 wherein comprises an anti fraud monitoring, detecting anomalies in the voting patterns for a better data integrity.

29. The method of claim 5 wherein each helpfulness vote influences the ranking model, giving a higher or a lower weight to the reviews from the predicate user or editorial review source.

30. The method of claim 5 wherein each fluctuation of the review's score that follow a user vote is being monitored by the ranking model.

31. The method of claim 1 comprises a normalization service, it is being used to allow the system to use any available review data even when the ranking scale is different on each source.

32. The method of claim 5 wherein each user input is being monitored and counted for a user ranking and for a static score purpose.

33. A computer-implemented method for calculating the product's score and ranking based on the review's score, reviews source ranking, product age and a dynamic weighting system in a given category or in the search result's with or without an attribute group.

34. The method of claim 2 wherein the review's score is a mathematical number calculated by the score calculator algorithm with a mathematical formula.

35. The method of claim 5 wherein the “reviews source ranking” is a mathematical number that embodies ranking information from the voting model in a mathematical algorithm.

36. The method of claim 4 wherein the review's age is reducing the score and the ranking results.
